(19) United States
(12) Patent Application Publication
(10) Pub. No.: US 2018/0167171 A1
(43) Pub. Date: Jun. 14, 2018

(54) HARQ Feedback Scheme for 5G New Radio

(71) Applicant: MEDIATEK INC., Hsinchu (TW)

(72) Inventors: Kuo-Ming Wu, Hsinchu (TW); Wei-Jen Chen, Hsinchu (TW); Abdelkader Medles, Cambridge (GB); Tao Chen, Beijing (CN); Ho-Chi Huang, Hsinchu (TW); Ju-Ya Chen, Hsinchu (TW)

(21) Appl. No.: 15/834,325

(22) Filed: Dec. 7, 2017

Related U.S. Application Data
(60) Provisional application No. 62/431,461, filed on Dec. 8, 2016.

(30) Foreign Application Priority Data
Dec. 6, 2017 (CN) PCT/CN2017/114794

(51) Int. Cl. H04L 1/18; H04W 74/02; H04W 72/12

(52) U.S. Cl. CPC H04L 1/1816; H04W 72/1205; H04W 74/02; H04L 1/1858

(57) ABSTRACT

A Hybrid Automatic Repeat Request (HARQ) feedback scheme that employs a multi-state NACK feedback processing is proposed. A transport block (TB) contains a plurality of code blocks (CBs). When all CBs of the TB are successfully decoded, a one-bit TB ACK is feedback. When at least one CB of the TB is not correctly decoded, a one-bit TB NACK is feedback. In addition, a multi-bit HARQ CB NACK feedback is provided. The multi-bit HARQ CB NACK can point more precisely to the erroneous parts of the TB and trigger efficient retransmission by skipping retransmission of successfully decoded CBs. The network can disable the multi-bit CB NACK for certain UEs, e.g., to reduce overhead. The UE can disable the multi-bit CB NACK, e.g., to save power.

### CROSS REFERENCE TO RELATED APPLICATIONS

This application claims priority under 35 U.S.C. § 119 from U.S. Provisional Application No. 62/431,461 entitled “An HARQ Scheme for 5G NR,” filed on Dec. 8, 2016, the subject matter of which is incorporated herein by reference.

### TECHNICAL FIELD

The disclosed embodiments relate to Hybrid Automatic Repeat Request (HARQ) operation, and more specifically, to HARQ feedback scheme in next generation 5G new radio (NR) mobile communication networks.

### BACKGROUND

A Long-Term Evolution (LTE) system offers high peak data rates, low latency, improved system capacity, and low operating cost resulting from simple network architecture. An LTE system also provides seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred as user equipments (UEs). Enhancements to LTE systems are considered so that they can meet or exceed International Mobile Telecommunications Advanced (IMT-Advanced) fourth generation (4G) standard.

The signal bandwidth for next generation 5G new radio (NR) system is estimated to increase to up to hundreds of MHz for below 6 GHz bands and even to values of GHz in case of millimeter wave bands. Furthermore, the NR peak rate requirement can be up to 20 Gbps, which is more than ten times of LTE. It is therefore expected that 5G NR system needs to support dramatically larger transport block (TB) sizes as compared to LTE, which result in a much more code block (CB) segments per TB. Three main applications in 5G NR system include enhanced Mobile Broadband (eMBB), Ultra-Reliable Low Latency Communications (URLLC), and massive Machine-Type Communication (MTC) under milli-meter wave technology, small cell access, and unlicensed spectrum transmission. Multiplexing of eMBB & URLLC within a carrier is also supported.

A technique referred to as Hybrid Automatic Repeat ReQuest (HARQ) is employed for error detection and correction. In a standard Automatic Repeat ReQuest (ARQ) method, error detection bits are added to data to be transmitted. In Hybrid ARQ, error correction bits are also added. When the receiver receives a data transmission, the receiver uses the error detection bits to determine if data has been lost. If it has, then the receiver may be able to use the error correction bits to recover (decode) the lost data. If the receiver is not able to recover the lost data using the error correction bits, then the receiver may use a second transmission of additional data (including more error correction information) to recover the data. Error correction can be performed by combining information from the initial transmission with additional information from one or more subsequent retransmissions.

Current mobile communication systems such as LTE have a rather simple HARQ feedback functionality. The conventional HARQ feedback scheme employs a single ACK/NACK bit (hence only two states are available) for a transport block. Normally, an HARQ feedback is ACK (i.e., state 1, A/N bit value=1) if all of the CBs in a TB are successfully decoded, and an HARQ feedback is NACK (i.e., state 2, A/N bit value=0) if one or more of the CBs fail in decoding. This means in such a scheme even a single failed CB will trigger retransmission of all CBs in a TB. This simple approach may not be efficient for further NR scenarios when the number of CBs in a TB is large (e.g., eMBB case) or when only a few CBs in a TB could not be reliably received (e.g., URLLC/eMBB multiplexing case). A solution is sought.

### SUMMARY

A Hybrid Automatic Repeat Request (HARQ) feedback scheme that employs a multi-state NACK feedback processing is proposed. The basic idea is to employ multiple feedback bits to utilize the HARQ functionality resources as efficient as possible. A transmitter encodes and transmits a transport block (TB) to a receiver. The TB contains a plurality of code blocks (CBs). When all CBs of the TB are successfully decoded, a one-bit TB ACK is feedback to the receiver. When at least one CB of the TB is not correctly decoded, a one-bit TB NACK is feedback to the receiver. In addition, a multi-bit HARQ CB NACK feedback is provided to the receiver. The multi-bit HARQ CB NACK can point more precisely to the erroneous parts of the TB and trigger efficient retransmission by skipping retransmission of successfully decoded CBs. The network can disable the multi-bit CB NACK for certain UEs, e.g., to reduce overhead. The UE can disable the multi-bit CB NACK, e.g., to save power. To save the precious resources and to further reduce the control overhead, a multiple access mechanism can be combined with the multi-bit CB NACK feedback scheme.

In one embodiment, a receiver receives a transport block (TB) from a transmitter in a mobile communication network. The TB is encoded to a plurality of code blocks (CBs). The receiver decodes the plurality of CBs and performing a hybrid automatic repeat request (HARQ) operation. The receiver determines a first HARQ feedback status. The first HARQ feedback status is ACK if all CBs are correctly decoded, and the first HARQ feedback status is NACK if at least one CB is not correctly decoded. The receiver determines a second HARQ feedback status when the first HARQ feedback status is NACK. The second HARQ feedback status indicates information on erroneous status of the plurality of CBs.

In another embodiment, a transmitter encodes and transmits a transport block (TB) to a receiver in a mobile communication network. The TB is encoded to a plurality of code blocks (CBs). The transmitter receives a first hybrid automatic repeat request (HARQ) feedback status. The first HARQ feedback status is ACK if all CBs are correctly decoded, and the first HARQ feedback status is NACK if at least one CB is not correctly decoded. The transmitter receives a second HARQ feedback status when the first HARQ feedback status is NACK. The second HARQ feedback status indicates information on erroneous status of the plurality of CBs. Finally, the transmitter retransmits CBs that are not correctly decoded to the receiver while skipping retransmission for CBs that are correctly decoded.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network with a multi-state NACK feedback processing for HARQ operation in accordance with one novel aspect.

FIG. 2 illustrates a first embodiment of an HARQ scheme with multi-state NACK feedback in accordance with one novel aspect.

FIG. 3 illustrates a second embodiment of an HARQ scheme with multi-state NACK feedback in accordance with one novel aspect.

FIG. 4 illustrates a third embodiment of an HARQ scheme with multi-state NACK feedback using multiple access in accordance with one novel aspect.

FIG. 5 illustrates a sequence flow between a base station and a plurality of UEs for HARQ operation with multi-state NACK feedback.

FIG. 6 is a flow chart of a method of providing multi-state NACK feedback for HARQ operation from receiver perspective in accordance with one novel aspect.

FIG. 7 is a flow chart of a method of providing multi-state NACK feedback for HARQ operation from transmitter perspective in accordance with one novel aspect.

### DETAILED DESCRIPTION

Reference will now be made in detail to some embodiments of the invention, examples of which are illustrated in the accompanying drawings.

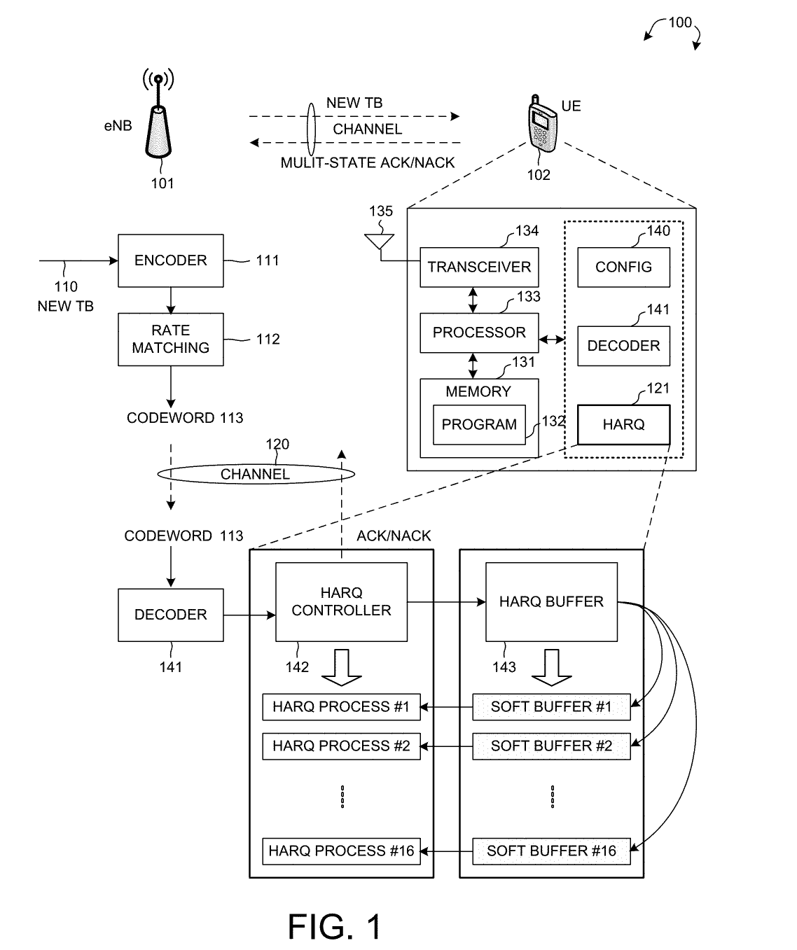

FIG. 1 illustrates a next generation 5G new radio (NR) mobile communication network 100 with a multi-state NACK feedback processing for Hybrid Automatic Repeat Request (HARQ) operation in accordance with one novel aspect. Mobile communication network 100 is a 5G NR system having a base station BS 101 and a user equipment UE 102. Three main applications in 5G NR include enhanced Mobile Broadband (eMBB), Ultra-Reliable Low Latency Communications (URLLC), and massive Machine-Type Communication (MTC) under milli-meter wave technology, small cell access, and unlicensed spectrum transmission. Multiplexing of eMBB & URLLC within a carrier is supported. For downlink (DL) data transmission, at the transmitter side, BS 101 takes a new transport block (TB) as encoder input, performs encoding via encoder 111 and rate matching via rate-matching module 112, and generates a codeword 113 corresponding to TB 110 to be transmitted to UE 102 over wireless channel 120. The BS then performs rate matching based on physical resource allocation. It is expected that 5G NR needs to support dramatically larger TB sizes as compared to LTE, which result in much more code block (CB) segments per TB. In another word, TB 110 may contain up to one hundred CBs.

At the receiver side, UE 102 receives codeword 113 having multiple CBs, performs decoding via decoder 141, and sends out an ACK or NACK back to BS 101 based on the decoding result. If a new TB turns out to be an erroneous TB after decoding, then BS 101 retransmits the TB after receiving the NACK, and UE 102 performs HARQ via HARQ controller 142 and HARQ buffer 143. For each new erroneous TB, the HARQ controller 142 assigns an HARQ process, stores the erroneous TB in a corresponding soft buffer allocated from HARQ buffer 143, and waits for retransmission data from BS 101 to perform data recovery. For example, TB#1 is associated with HARQ process #1 having soft buffer #1, TB#2 is associated with HARQ process #2 having soft buffer #2 . . . and so on so forth.

The conventional HARQ feedback scheme employs a single ACK/NACK bit (hence only two states are available) for a transport block. Normally, an HARQ feedback is ACK (i.e., state 1, A/N bit value=1) if all of the CBs in a TB are successfully decoded, and an HARQ feedback is NACK (i.e., state 2, A/N bit value=0) if one or more of the CBs fail in decoding. This means in such a scheme even a single failed CB will trigger retransmission of all CBs in a TB. This simple approach may not be efficient for further NR scenarios when the number of CBs in a TB is large (e.g., eMBB case) or when only a few CBs in a TB could not be reliably received (e.g., URLLC/eMBB multiplexing case).

In accordance with one novel aspect, an HARQ feedback scheme that employs a multi-state NACK feedback processing is proposed. The basic idea is to employ multiple feedback bits to utilize the HARQ functionality resources as efficient as possible. In other words, a multi-bit HARQ CB feedback, and hence multi-state NACK processing, can point more precisely to the erroneous parts of a TB and trigger an efficient retransmission by skipping retransmission of successfully decoded CBs. There could be various approaches and architectures in realizing the proposed HARQ feedback scheme.

FIG. 1 further illustrates a simplified block diagram of UE 102 that carries embodiments of the present invention. UE 102 comprises memory 131, a processor 133, an RF transceiver 134, and an antenna 135. RF transceiver 134, coupled with antenna 135, receives RF signals from antenna 135, converts them to baseband signals and sends them to processor 133. RF transceiver 134 also converts received baseband signals from processor 133, converts them to RF signals, and sends out to antenna 135. Processor 133 processes the received baseband signals and invokes different functional modules and circuits to perform features in UE 102. Memory 131 stores program instructions and data 132 to control the operations of UE 102. The program instructions and data 132, when executed by processor 133, enables UE 102 to decode TBs and perform HARQ accordingly.

UE 102 also comprise various function modules and circuits that can be implemented and configured in a combination of hardware circuits and firmware/software codes being executable by processors 133 to perform the desired functions. Each functional module or circuit may comprise a processor together with corresponding program codes. In one example, UE 102 comprises a configuration module 140 for determining and configuring HARQ related parameters, a decoder 141 that decodes new TBs, and an HARQ module 121 further comprising HARQ controller 142 and HARQ buffer 143 for supporting the HARQ scheme with multi-state NACK feedback.

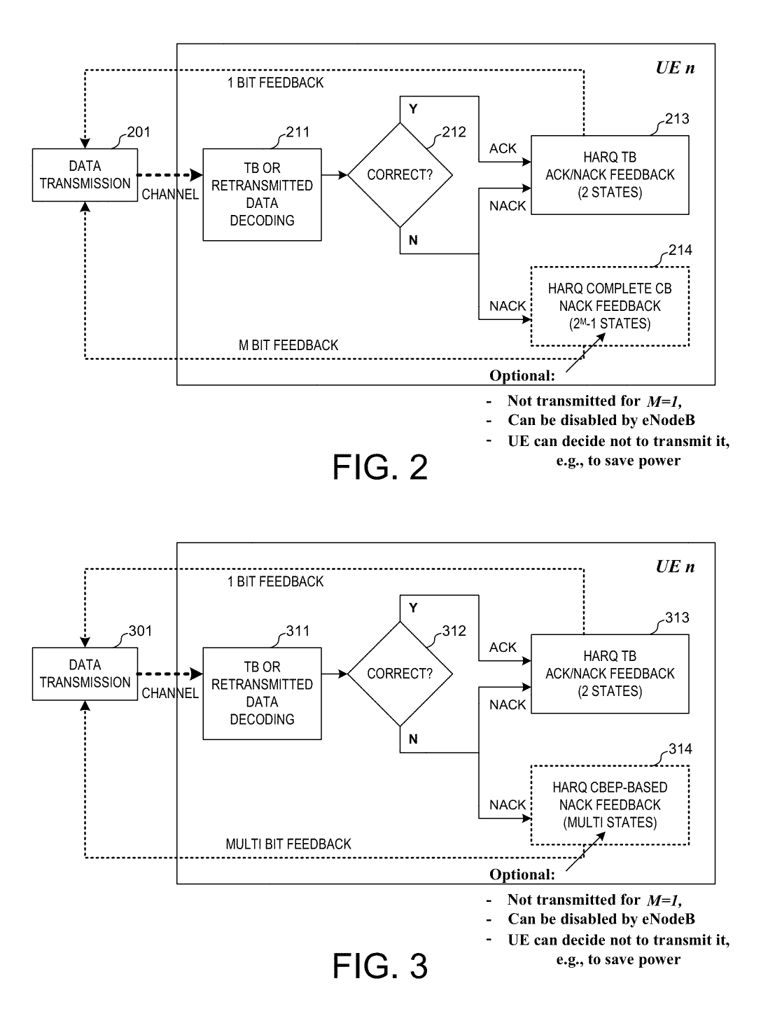

FIG. 2 illustrates a first embodiment of an HARQ scheme with multi-state NACK feedback in accordance with one novel aspect. In the embodiment of FIG. 2, at the transmitter side, a new TB is encoded into a plurality of CBs by a base station to be transmitted over a wireless channel in step 201. At the receiver side, a UE performs TB or retransmitted data decoding in step 211 and checks whether the decoding is successful in step 212. If all the CBs in a TB are correctly decoded, then HARQ TB ACK is feedback to the transmitter in step 213. On the other hand, if at least one CB in a TB is not correctly decoded, then HARQ TB NACK is feedback to the transmitter in step 213, with additional HARQ CB ACK/NACK feedback information sent back to the transmitter in step 214.

In the embodiment of FIG. 2, a complete CB NACK feedback scheme is applied, where additional M-bit message (M is the number of CBs per TB) is used for CB NACK feedback. The mth bit of the M-bit message represents the A/N status of the mth CB. When the transmitter is informed by the M-bit message, only the failed segments of the TB (the CBs with NACK status) will be retransmitted. The correctly decoded segments of the TB (the CBs with ACK status) are skipped for retransmission so that the resources used for re-transmission are reduced. In other words, new data transmissions can be activated on those freed resources. This in turn increases the overall efficiency of the HARQ process as well as the throughput performance. Theoretically, this approach makes the best use of the part that does not require HARQ retransmission and can thus achieve the most throughput gain potentially. However, this approach also imposes large control channel signaling overhead to the communication link. For N concurrent the HARQ CB NACK processes (or N UE's), it requires a dedicated radio resources of size NM bits for feedback reporting. In the case of M=1 (1 TB contains 1 CB) only, the CB NACK feedback is not required, since the TB ACK/NACK is sufficient in this case.

The separation of the ACK/NACK feedback into 1-bit TB ACK/NACK and multi-bit CB NACK feedback is meant to ensure the best compromise between reliability, overhead and performance. The 1-bit TB ACK/NACK can be heavily encoded to ensure full reliability even when the multi-bit CB NACK is not transmitted or cannot be decoded. On the other hand, the multi-bit CB NACK feedback is targeted to improve efficiency and therefore a relatively light encoding can be used to reduce overhead. However, the encoding need to include protection against false detection, for example by including parity check bits, thus ensuring that either the CB NACK feedback is retrieved correctly and hence the required CBs are re-transmitted or the retrieval of CB NACK feedback fails and full re-transmission of the TB is triggered. To reduce the HARQ CB feedback overhead, the M-bit CB NACK feedback in step 214 can be optional. The network can configure certain UEs to not transmit the multi-bit CB NACK feedback. Besides, each UE can decide not to transmit the multi-bit CB NACK feedback. For example, at the cell edge, the multi-bit CB NACK feedback can be disabled by a UE to save power.

FIG. 3 illustrates a second embodiment of an HARQ scheme with multi-state NACK feedback in accordance with one novel aspect. FIG. 3 is similar to FIG. 2, where steps 301-314 perform similar functionalities. In the embodiment of FIG. 3, however, a CB error pattern-based (CBEP-based) NACK feedback scheme is applied in step 314, where CB error pattern is used to reduce the number of HARQ feedback bits. Under the CBEP-based approach, the receiver node feedback the most useful information to the transmitter node for an efficient retransmission when a TB is not correctly decoded, such as the information of the most probable erroneous CB patterns. For instance, say 90%˜95% normalized throughput (normalized throughput=total correctly received bits/total transmitted bits), it is likely that a TB NACK is the result of one or few erroneous CB's (where the exact observation could be obtained from analysis, simulations, or field tests). Therefore, one possible reduced-complexity approach is to record the most probable one-CB-error NACK cases in detail but simply taking the other NACK cases as the whole-TB-error scenario. With this approach, the number for HARQ NACK feedback bits for each UE can be reduced to ceil (log₂M+1), which is a dramatic overhead reduction as compared to the complete CB approach, especially when the number of CBs in a TB is large. Similarly, for larger granularity, say the error patterns within two consecutive CB positions, only ceil (log₂M) bits are required for the HARQ NACK feedback. The selection of error pattern granularity is a trade-off between feedback size and the desired throughput performance. Larger granularity of feedback error patterns comes with less feedback overhead but sacrifices throughput performance. Moreover, the power saving (or fallback to legacy HARQ scheme) mechanism described in FIG. 2 above can apply to the CBEP-based scheme as well.

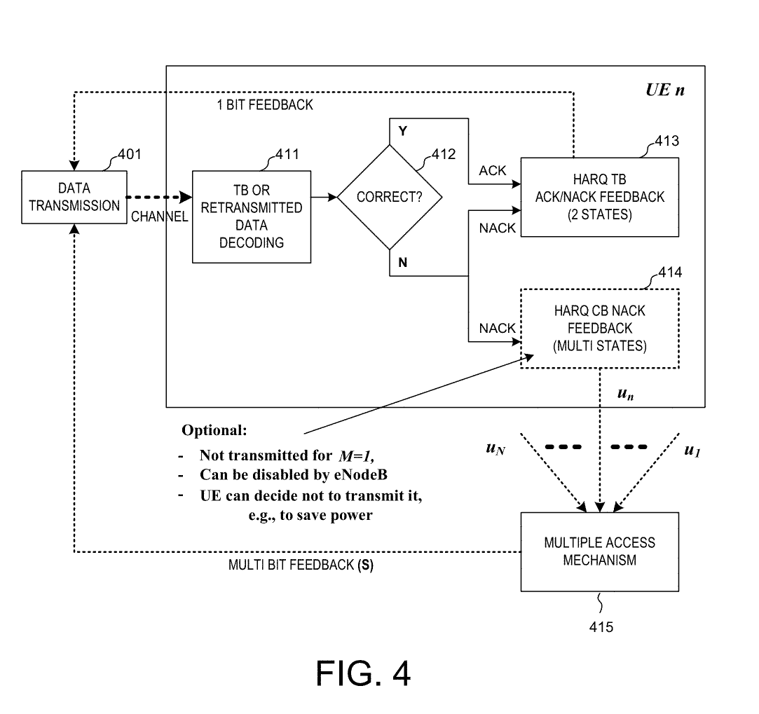

FIG. 4 illustrates a third embodiment of an HARQ scheme with multi-state NACK feedback using multiple access in accordance with one novel aspect. The HARQ feedback approaches described above employ a dedicated radio resource for each UE for feedback reporting. To save the precious radio resources and to further reduce the control overhead, a multiple access (MA) mechanism can be combined with the proposed HARQ feedback scheme. FIG. 4 is similar to FIG. 2, where steps 401-414 perform similar functionalities. As depicted in FIG. 4, however, MA mechanism 415 is employed to multiplex the multi-bit CB NACK feedback messages of N UEs. Through the MA operation, N UEs share the same HARQ feedback resource and the dedicated control channel overhead is expected to be significantly reduced.

In a first example, a combination of the complete CB NACK feedback approach and a MA mechanism among N UEs is applied. An HARQ TB ACK/NACK 1-bit feedback is always transmitted in step 413. However, when the TB decoding fails, an additional M-bit message u is used for CB NACK feedback in step 414. The feedback messages uₙ (n=1, . . . , N) from various UEs are multiplexed through MA mechanism in step 415, where the MA scheme is not limited to any approach (e.g., it could be any of superposition, CDMA, CSMA, TDMA, FDMA, etc.). That is, the MA scheme can include contention-based methods and contention-free methods. The MA resource can be indicated by base stations as a common resource for dedicated or contention based transmission. Base stations can also reallocate the MA resource dynamically or semi-statically.

The resulting output signal s from MA mechanism 415 is feedback to the transmitter. If the feedback message of UE n is retrieved successfully, the transmitter only retransmits the CBs indicated by the feedback content. In other words, a throughput gain as in the complete CB NACK approach can be obtained in such a scenario. On the other hand, if the transmitter fails to retrieve the feedback message, all CBs in the TB of UE n will be retransmitted (i.e., the approach degenerates into the conventional scheme). With this approach, N UEs share the same multi-bit CB NACK feedback resource and the dedicated control channel overhead for the additional CB feedback reporting is reduced greatly from NM bits to x bits, where x is the length of the MA multiplexed signal s, in case superposition or CSMA is employed x=M. It is expected that in case the probability of TB decoding failure is relatively low, multiple access schemes such as superposition or CSMA will perform very well, since at any time only a reduced subset of users will try to transmit a multi-bit CB NACK at the same time.

In a second example of HARQ feedback using multiple access, the combination of a CBEP-based NACK feedback as described in FIG. 3 and a multiple access mechanism can further reduce the feedback size and save the precious dedicated radio resources. The actual choice of the schemes depends on the NR system parameter design as well as the compromise between performance and control overhead/complexity.

Note the HARQ scheme with multi-bit CB NACK feedback is applicable to both downlink and uplink data transmission. In the illustration of FIGS. 2-3, the transmitter is the base station while the receiver is the UE. However, it is also applicable if the transmitter is the UE while the receiver is the base station. On the other hand, the idea of combining the multiple access (MA) mechanism for HARQ feedback is only applicable to downlink data transmission. In addition, it is optional to apply the MA mechanism. The concept of multi-bit HARQ feedback and the MA mechanism are independent from each other.

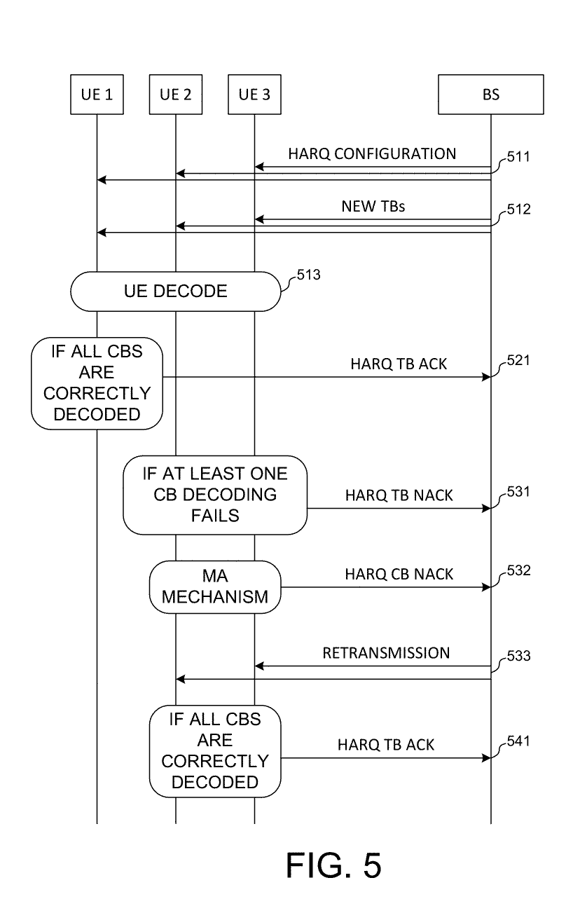

FIG. 5 illustrates a sequence flow between a base station and a plurality of UEs for HARQ operation with multi-state NACK feedback. In step 511, a base station sends HARQ configuration to UE1, UE2, and UE3. For example, the HARQ configuration may enable or disable the multi-state NACK feedback for certain UEs. In step 512, the base station transmits new TBs to each of the UEs. For example, TB1, TB2, and TB3 are encoded including multiple CBs to be transmitted to UE1, UE2, and UE3, respectively. In step 513, each UE receives its new TB and performs TB decoding. In step 521, if all CBs are correctly decoded (e.g., UE1), then UE1 transmits a one-bit HARQ TB ACK to the base station. In step 531, of at least one CB is not correctly decoded (e.g., UE2 and UE3), then UE2 and UE3 each transmits a one-bit HARQ TB NACK to the base station. In addition, UE2 and UE3 apply a multiple access mechanism in step 532 and transmits HARQ CB NACK to the base station. For example, the feedback from UE2 is successfully retrieved by the base station, while the feedback from UE3 fails to be retrieved by the base station. Note that the MA mechanism in step 532 is optional, UE2 or UE3 could also transmit its own HARQ CB NACK to the base station directly. In step 533, the base station only retransmits the CBs with NACK status to UE2, while retransmits all CBs to UE3. In step 541, if all CBs are correctly decoded (e.g., both UE2 and UE3), then UE2 and UE3 each transmits a one-bit HARQ TB ACK to the base station.

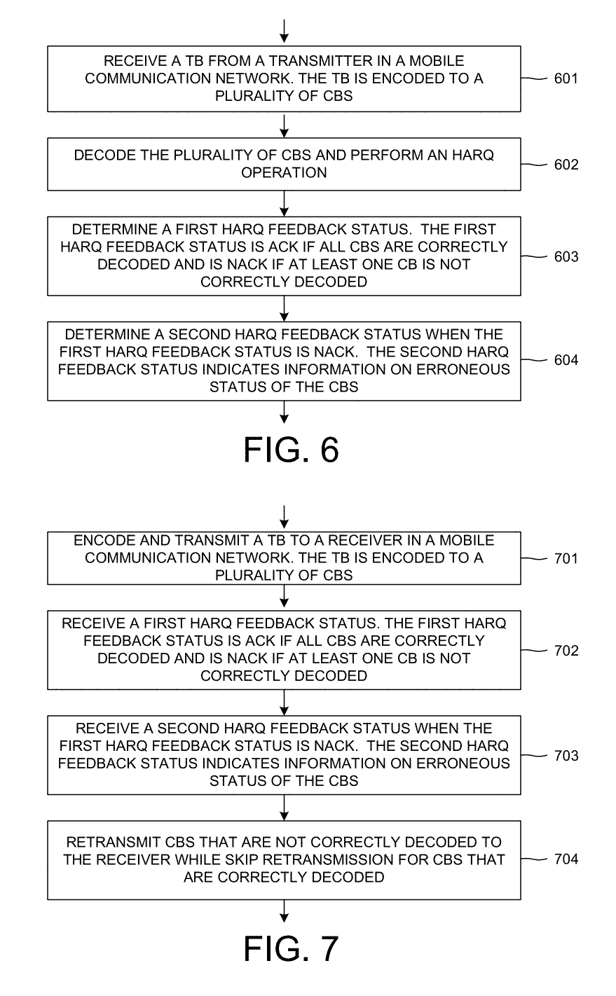

FIG. 6 is a flow chart of a method of providing multi-state NACK feedback for HARQ operation from receiver perspective in accordance with one novel aspect. In step 601, a receiver receives a transport block (TB) from a transmitter in a mobile communication network. The TB is encoded to a plurality of code blocks (CBs). In step 602, the receiver decodes the plurality of CBs and performing a hybrid automatic repeat request (HARQ) operation. In step 603, the receiver determines a first HARQ feedback status. The first HARQ feedback status is ACK if all CBs are correctly decoded, and the first HARQ feedback status is NACK if at least one CB is not correctly decoded. In step 604, the receiver determines a second HARQ feedback status when the first HARQ feedback status is NACK. The second HARQ feedback status indicates information on erroneous status of the plurality of CBs.

FIG. 7 is a flow chart of a method of providing multi-state NACK feedback for HARQ operation from transmitter perspective in accordance with one novel aspect. In step 701, a transmitter encodes and transmits a transport block (TB) to a receiver in a mobile communication network. The TB is encoded to a plurality of code blocks (CBs). In step 702, the transmitter receives a first hybrid automatic repeat request (HARQ) feedback status. The first HARQ feedback status is ACK if all CBs are correctly decoded, and the first HARQ feedback status is NACK if at least one CB is not correctly decoded. In step 703, the transmitter receives a second HARQ feedback status when the first HARQ feedback status is NACK. The second HARQ feedback status indicates information on erroneous status of the plurality of CBs. In step 704, the transmitter retransmits CBs that are not correctly decoded to the receiver while skipping retransmission for CBs that are correctly decoded.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a transport block (TB) from a transmitter by a receiver in a mobile communication network, wherein the TB is encoded to a plurality of code blocks (CBs);
decoding the plurality of CBs and performing a hybrid automatic repeat request (HARQ) operation;
determining a first HARQ feedback status, wherein the first HARQ feedback status is ACK if all CBs are correctly decoded, and wherein the first HARQ feedback status is NACK if at least one CB is not correctly decoded; and
determining a second HARQ feedback status when the first HARQ feedback status is NACK, wherein the second HARQ feedback status indicates information on erroneous status of the plurality of CBs.

2. The method of claim 1, wherein the second HARQ feedback status comprises a plurality of bits, each bit indicates a corresponding CB decoding status.

3. The method of claim 1, wherein the second HARQ feedback status indicates a CB error pattern.

4. The method of claim 1, wherein the receiver receives a configuration from the transmitter to enable or disable the second HARQ feedback status.

5. The method of claim 1, wherein the receiver determines whether to enable or disable the second HARQ feedback status.

6. The method of claim 1, wherein the receiver performs a multiple access mechanism with other receivers for transmitting the second HARQ feedback status to the transmitter.

7. The method of claim 6, wherein the multiple access mechanism is contention-based or contention-free over radio resources allocated by the transmitter.

8. A user equipment (UE) comprising:
A radio frequency (RF) receiver that receives a transport block (TB) from a transmitter in a mobile communication network, wherein the TB is encoded to a plurality of code blocks (CBs);
a decoder that decodes the plurality of CBs and performing a hybrid automatic repeat request (HARQ) operation;
an HARQ controller that determines a first HARQ feedback status, wherein the first HARQ feedback status is ACK if all CBs are correctly decoded, and wherein the first HARQ feedback status is NACK if at least one CB is not correctly decoded; and
an RF transmitter that transmits a second HARQ feedback status when the first HARQ feedback status is NACK, wherein the second HARQ feedback status indicates information on erroneous status of the plurality of CBs.

9. The UE of claim 8, wherein the second HARQ feedback status comprises a plurality of bits, each bit indicates a corresponding CB decoding status.

10. The UE of claim 8, wherein the second HARQ feedback status indicates a CB error pattern.

11. The UE of claim 8, wherein the UE receives a configuration from the base station to enable or disable the second HARQ feedback status.

12. The UE of claim 8, wherein the UE determines whether to enable or disable the second HARQ feedback status.

13. The UE of claim 8, wherein the UE performs a multiple access mechanism with other UEs for transmitting the second HARQ feedback status to the base station.

14. The UE of claim 13, wherein the multiple access mechanism is contention-based or contention-free over radio resources allocated by the base station.

15. A method, comprising:
encoding and transmitting a transport block (TB) from a transmitter to a receiver in a mobile communication network, wherein the TB is encoded to a plurality of code blocks (CBs);
receiving a first hybrid automatic repeat request (HARQ) feedback status, wherein the first HARQ feedback status is ACK if all CBs are correctly decoded, and wherein the first HARQ feedback status is NACK if at least one CB is not correctly decoded;
receiving a second HARQ feedback status when the first HARQ feedback status is NACK, wherein the second HARQ feedback status indicates information on erroneous status of the plurality of CBs; and
retransmitting CBs that are not correctly decoded to the receiver while skipping retransmission for CBs that are correctly decoded.

16. The method of claim 15, wherein the second HARQ feedback status comprises a plurality of bits, each bit indicates a corresponding CB decoding status.

17. The method of claim 15, wherein the second HARQ feedback status indicates a CB error pattern.

18. The method of claim 15, wherein the transmitter sends a configuration to the receiver to enable or disable the second HARQ feedback status.

19. The method of claim 15, wherein the transmitter allocates radio resources to a plurality of receivers for sending the second HARQ feedback status using a multiple access mechanism.

20. The method of claim 19, wherein the multiple access mechanism is contention-based or contention-free over the allocated radio resources.
